(19) United States
(12) Patent Application Publication
(10) Pub. No.: US 2003/0000099 A1
(43) Pub. Date: Jan. 2, 2003

(54) Tape measure having illumination device

(76) Inventor: Chien-Kuo Wang, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/893,280

(22) Filed: Jun. 28, 2001

(51) Int. Cl. G01B 3/10

(52) U.S. Cl. 33/760

(57) ABSTRACT

A tape measure includes a case having a reel of tape received therein and a light is engaged with the front surface of case and located above a slot from which the tape is pulled. A light switch is connected to a rear surface of the case and electrically connected to the light so as to light up the marks on the tape.

### FIELD OF THE INVENTION

The present invention relates to a tape measure having an illumination device for convenience of illumination of the marks on the tape.

### BACKGROUND OF THE INVENTION

A conventional tape measure generally includes a case and a reel of the tape is received in the case. An end of the tape can be pulled out from the case and marks are printed on the tape so as to measure a distance between two points. A lock and rewind switch is located on a front surface on the case in order to hold or fix the tape. This is especially convenient for the users to check the marks on the tape. However, the conventional tape measure lacks of light or illumination device so that the tape measure is not used in a dark area. There could not have enough illumination device at each of the two points to be measured so that when the users use the tape measure in the dark, the users have to prepare a torchlight to see the marks on the tape.

### SUMMARY OF THE INVENTION

In accordance with one aspect of the present invention, there is provided a tape measure which comprises a case having a reel of tape received therein and a slot is defined in a front surface of the case so that the tape is pulled from the slot. A lock and rewind switch is pivotally connected to the case and a light is engaged with the front surface of case and located above the slot. A light switch is connected to a rear surface of the case and electrically connected to the light. A space is defined in the case for receiving a battery therein.

The primary object of the present invention is to provide a tape measure that has a light connected to the case so as to assist the users to see the marks on the tape in dark.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show a tape measure of the present invention;

FIG. 2 is an exploded view to show the tape measure of the present invention;

FIG. 3 is an exploded view to show the tape measure of the present invention wherein the case is to be composed by two parts;

FIG. 4 is an illustrative side view to show the tape measure of the present invention, and

FIG. 5 is an illustrative side view to show the tape is light up by using the light of the tape measure of the present invention.

### DETAILED DESCRIPTION OF THE PREFERRED EMBODIMENT

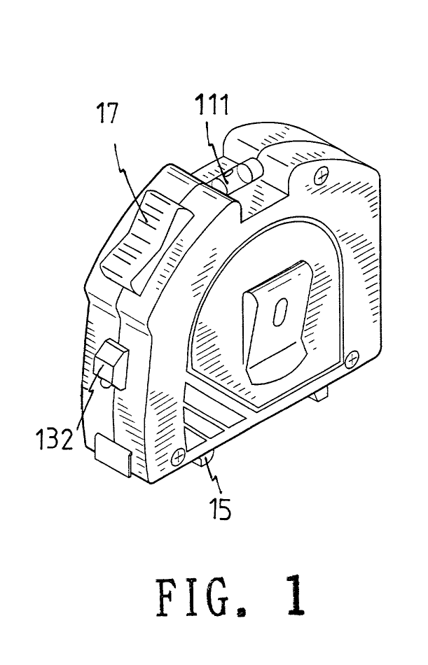

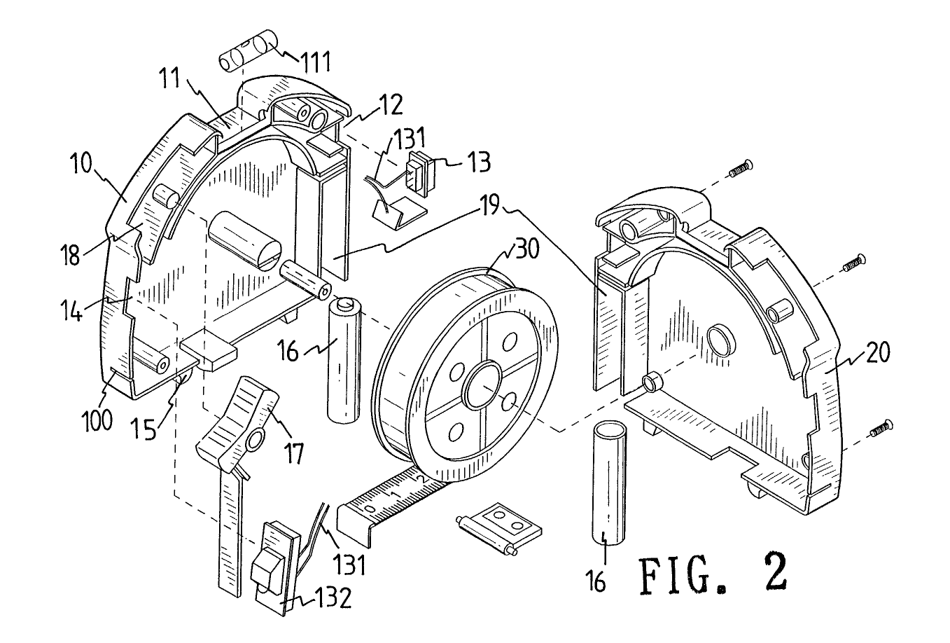

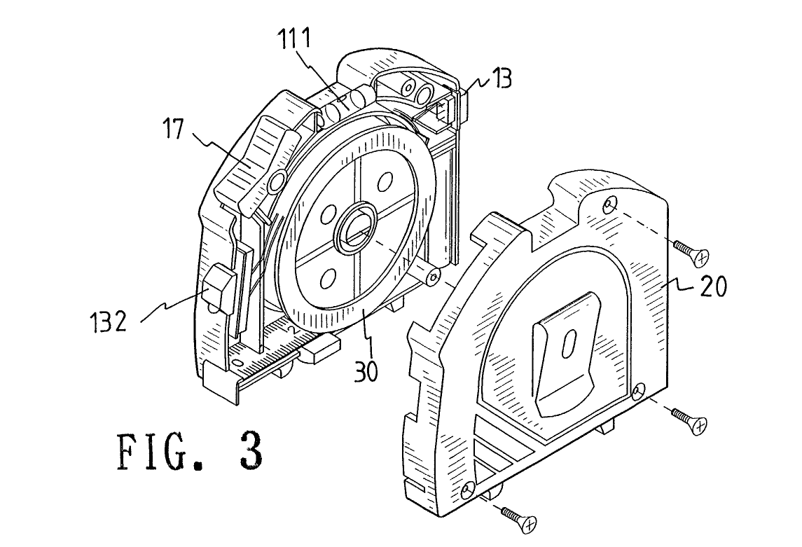

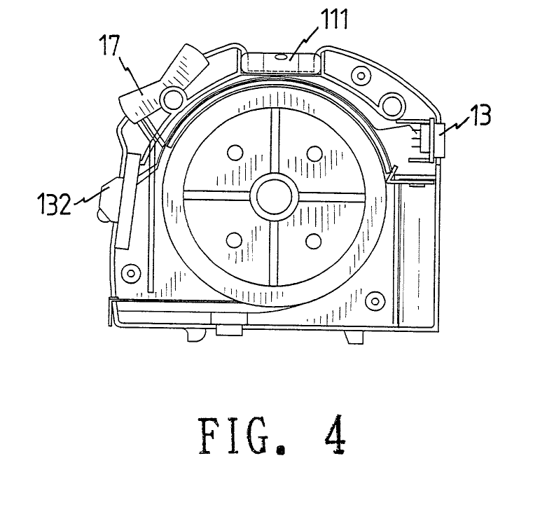

Referring to FIGS. 1 to 4, the tape measure of the present invention comprises a case which is composed of a first part 10 and a second part 20 which is to be matched with the first part 10 by bolts. A reel of tape 30 is mounted to a shaft extending from an inside of the first part 10 and a slot 100 defined in a front surface of the case so that the tape 30 is pulled from the slot 100. A recess 18 is defined in a front surface of the first part 10 and a lock and rewind switch 17 is pivotally received in the recess 18 and a aperture 14 is defined through the case so that a light 132 is engaged with the aperture 14 of case. The light 132 is located above the slot 100. A light switch 13 is connected to a recess 12 defined in a rear surface of the case and electrically connected to the light 132 by wires 131. A space 19 is defined in the case so as to receive a battery 16 therein which powers the light 132.

The case has a recess 11 defined in a top thereof and a leveling device 111 is received in the recess 11. A plurality legs 15 extend from a bottom of the case such that when the legs 15 are put on a ground, the user may check the level by checking the bulbs in the leveling device 111.

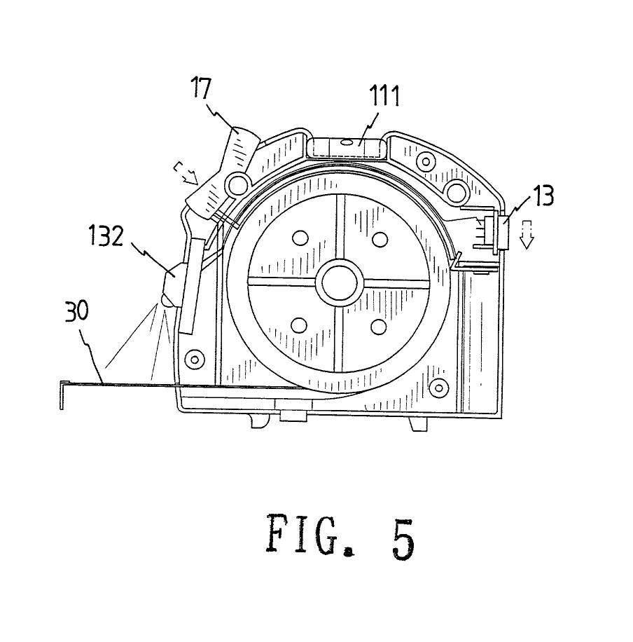

A shown in FIG. 5, the light 132 turns on by pulling the light switch 13 and the marks on the tape 30 can be seen clearly in dark.

While we have shown and described the embodiment in accordance with the present invention, it should be clear to those skilled in the art that further embodiments may be made without departing from the scope of the present invention.

What is claimed is:

1. A tape measure comprising:
a case having a reel of tape received therein and a slot defined in a front surface of said case so that said tape is pulled from said slot, a lock and rewind switch pivotally connected to said case and a light engaged with said front surface of case and located above said slot, a light switch connected to a rear surface of said case and electrically connected to said light, a space defined in said case and being adapted to receive a battery therein.

2. The tape measure as claimed in claim 1, wherein said case has a recess defined in a top thereof and a leveling device is received in said recess.

3. The tape measure as claimed in claim 1 further comprising a plurality legs extending from a bottom of said case.
